(19) United States
(12) Patent Application Publication
(10) Pub. No.: US 2014/0070429 A1
(43) Pub. Date: Mar. 13, 2014

(54) Dirt disposal structure of aquarium protein skimmer

(71) Applicant: Jyh-Ying Lee, Changhua (TW)

(72) Inventor: Jyh-Ying Lee, Changhua (TW)

(21) Appl. No.: 13/607,840

(22) Filed: Sep. 10, 2012

(51) Int. Cl. A01K 63/04

(52) U.S. Cl. 261/6

(57) ABSTRACT

In a dirt disposal structure of an aquarium protein skimmer, a foam generating chamber formed in a container body is a porous bubble guide column having pores for interconnecting a dirt collection box with the foam generating chamber. Water in an aquarium tank is entered into the foam generating chamber by a liquid-gas mixing device to produce fine air bubbles. Since the air bubbles entered into the pores contain a very small amount of moisture, small protein or peptide dirt is discharged in a concentrated form. A dirt collection box collects concentrated small protein or peptide dirt with a small amount of water to prevent the dirt collection box from cleaning the dirt too frequently. The small protein or peptide dirt rises with the air bubbles from the pores to an outlet, and the continuously rising air bubbles can stop the dirt from returning into the aquarium tank.

### FIELD OF THE INVENTION

The present invention relates to a dirt disposal structure capable of avoiding frequent cleaning of a dirt collection box, assuring the effectiveness of discharging protein dirt, and achieving a high protein dirt removal efficiency, in particular to the dirt disposal structure of an aquarium protein skimmer.

### BACKGROUND OF THE INVENTION

It is well known that water filter is an indispensable equipment for keeping aquatic organisms. Besides the water filter, additional equipments are required according to different aquatic organisms. For example, the quality of seawater in an aquarium tank may be deteriorated by fish excretion and urine when breeding seawater fish, so that excessive toxics such as denatured ammonia gas or nitrites is produced in the water, and the water filter cannot remove dead bodies of bacteria and viruses, and tiny dirt, so that a protein skimmer or remover is needed.

Conventional protein skimmers or removers include an air pump type protein skimmer and a water pump type protein skimmer.

The conventional air pump type protein skimmer as disclosed in TAIWAN Utility Model Publication No. 236771, entitled “Aquarium protein skimmer structure comprises an air pump for pumping air from wooden air stones, so that when air bubbles are produced small purities or proteins in water will be turned over, and dirt including purities or proteins with a smaller specific gravity than water will flow upwardly along a guide pipe to a dirt collection ring at the top of an aquarium tank.

The conventional water pump type protein skimmers as disclosed in TAIWAN Pat. Publication No. 273079 entitled “Aquarium water purifier structure, TAIWAN Publication No. M304218 entitled “Small protein skimmer for aquaculture, TAIWAN Pat. Publication No. M310595 entitled “External aquarium seawater foam removing filter” and TAIWAN Pat. Publication No. M343382 entitled “Air-water mixing device of protein skimmer” have a liquid-gas mixing type water pumping or submerged motor connected to external air and integrally installed in a container, and when the motor is used to extract liquid water from a fish tank into the space, small air bubbles are produced, so that small purities or proteins in the liquid water are brought to a dirt output pipe by the rising air bubbles and flow into a dirt collection box. As disclosed in TAIWAN Pat. Publication No. 223741 entitled “Aquarium water purifying and filtering device”, a liquid-gas mixing type water pump connected to external air is installed separately outside a container, and the motor is used for extracting liquid water contained in the fish tank and mixed with air into the container to produce small air bubbles, and the liquid water delivered into the container contains a large amount of small air bubbles, so that the small impurities or proteins are brought to the dirt output pipe by the rising air bubbles and flow into the dirt collection box. As disclosed in TAIWAN Pat. Publication No. 228647 entitled “Multifunctional aquarium filtering air-mixing pipe structure”, R.O.C. Pat. Publication No. 236773 entitled “Aquarium protein fractionator”, TAIWAN Pat. Publication No. 237609 entitled “Aquarium water purification device (patent of addition 1) have a separate external water pump for extracting liquid water from a fish tank into a container and external air is supplied, so that the liquid water entering into the container produces small air bubbles, and small impurities or proteins are brought to the dirt output pipe by the small rising air bubbles and flow into the dirt collection box.

Although various types of conventional protein skimmers or devices described above can achieve the effects of bringing dirt and proteins in water by air bubbles to the dirt output pipe or the guide pipe and discharging them to the outside, the pipe diameter of the dirt output pipe or the guide pipe is very large. If the air bubbles are too small, then almost all air bubbles with the small buoyancy will be cracked or broken before arriving to the outlet of the output pipe or the guide pipe due to their expansion after leaving the water. As a result, most of the small impurities, proteins or dirt return to the container or the fish tank liquid water, and the effect of removing the small impurities or proteins will be affected significantly. If the air bubbles are large enough, the air bubbles with a large buoyancy will carry too much moisture together and flow together with the small impurities or proteins to a dirt collection ring, a dirt collection box or a dirt collection cup, and the dirt will fill up the storage space quickly, and it is necessary to clean up the dirt frequently. In other words, the conventional protein skimmers always have the problems of a poor effect and a low efficiency of removing the protein and dirt, and require to clean up the dirt and to remove more water more frequently and inconveniently. Obviously, the conventional protein skimmers or devices require improvements.

### SUMMARY OF THE INVENTION

Therefore, it is a primary objective of the present invention to provide a dirt disposal structure of an aquarium protein skimmer, comprising: a container body, a foam generating chamber disposed in the container body, a dirt disposal portion disposed at an upper end of the foam generating chamber, and a breathable dirt collection box installed outside an outlet end of the dirt disposal portion, characterized in that the dirt disposal portion is a porous bubble guide column having a plurality of pores formed in an axial direction of the column for interconnecting the dirt collection box with the foam generating chamber, such that the liquid water in an aquarium tank is entered into the foam generating chamber of the container body through the operation of the liquid-gas mixing device to produce fine air bubbles; and the fine air bubbles are used to damage protein structures in water, so that the air bubbles attached with broken small protein or peptide dirt rise to the dirt disposal portion and then the air bubbles can be passed through the pores of the dirt disposal portion of the air bubble guide column and discharged, the fine air bubbles with buoyancy levitate to the inlet positions of the pores, and a weak pushing force is produced by the capillary action of the pores, so that the fine air bubbles enter into the pores continuously, and the rising air bubbles bring the attached small protein or peptide dirt to the outlet positions of the pores, and the dirt is cracked in form of foams as the air bubbles arrive the outlets, so that the small protein or peptide dirt is discharged or permeated to the outside through the outlets of the pores and the dirt flowing into dirt collection box is collected. Since the rising air bubbles entered into the pores continuously only contain a very small amount of moisture, therefore the small protein or peptide dirt is discharged in a concentrated form to allow the collection space of the dirt collection box to collect less liquid water and temporarily store concentrated small protein or peptide dirt, so as to avoid cleaning the dirt in the dirt collection box frequently, and when the small protein or peptide dirt rise together with the air bubbles in the pores to the outlets, other continuously rising air bubbles stop the small protein or peptide dirt from returning into the aquarium tank, so as to assure the effectiveness of discharging the protein dirt and improve the efficiency of removing the protein dirt.

Another objective of the present invention is to provide a dirt disposal structure of an aquarium protein skimmer, wherein a socket is formed at an upper end of the container body, and the dirt disposal portion of the air bubble guide column is disposed inside the dirt collection box, and an installing portion is formed at an external bottom of the dirt collection box and disposed opposite to the container body, and an installing portion of the dirt collection box is sheathed on the socket of the container body, and inlet ends of the pores of the dirt disposal portion of the air bubble guide column are extended deeply into the foam generating chamber of the container body, so that when the rising fine air bubbles in the foam generating chamber arrive the inlets of the pores, the air bubbles enter into the pores naturally, and small protein or peptide dirt attached onto the air bubbles is moved to the outlet and discharged, and finally collected by a dirt collection box. Wherein, it is only necessary to withdraw the installing portion of the dirt collection box from the socket of the container body directly to clear or clean the dirt in the dirt collection box and the pores of the dirt disposal portion easily.

A further objective of the present invention is to provide a dirt disposal structure of an aquarium protein skimmer, wherein the dirt disposal portion of the air bubble guide column has a plurality of pores interconnected to the dirt collection box and the foam generating chamber, and a flared guide port is formed at an inlet end of the pore of the dirt disposal portion of the air bubble guide column, so that the air bubbles rising to the top of the foam generating chamber are guided by the guide port to achieve the effects of collecting the air bubbles at the inlet positions of the pores, moving the rising air bubbles into the pores smoothly.

Another objective of the present invention is to provide a dirt disposal structure of an aquarium protein skimmer, wherein a liquid inlet is disposed at the bottom of the foam generating chamber of the container body, and the foam generating chamber is interconnected to the outside through a liquid outlet of the container body, such that the container body is submerged into the aquarium tank, and a wooden air stone of a liquid-gas mixing device is installed in the liquid inlet of the container body and coupled to an air pump, and an air pump is used to input air into a wooden air stone, so that a large quantity of fine air bubbles is produced at the liquid inlet, and air bubbles bring the protein dirt in water to rise and pass through the pores of the dirt disposal portion of the air bubble guide column and flow into the dirt collection box. After the foam in the foam generating chamber is removed, clean water can be returned from the liquid outlet into the aquarium tank, so that the air bubbles with buoyancy rising in the liquid water inside the foam generating chamber drive the liquid water in the aquarium tank to circulate through the liquid inlet and enter into the foam generating chamber to produce the effects of clearing and cleaning the produced protein dirt continuously, so as to maintain a good quality of the liquid water in the aquarium tank for a long time easily.

Another objective of the present invention is to provide a dirt disposal structure of an aquarium protein skimmer, wherein the container body has a foam generating chamber therein, and a liquid inlet and a liquid outlet formed on the container body. The container body is submerged into the aquarium tank, and a liquid-gas mixing motor of a liquid-gas mixing device is installed at the internal bottom of the foam generating chamber, and an air-water mixing module on the liquid-gas mixing motor is coupled to the liquid inlet and connected to the external air through an air inlet pipe. With the operation of the liquid-gas mixing motor, when the liquid water in the aquarium tank is pumped into the foam generating chamber, the air-water mixing module produces a large amount of fine air bubbles, and the air bubbles bring the protein dirt in water to rise and pass through the pores of the dirt disposal portion of the air bubble guide column and flow into the dirt collection box. After the foam in the foam generating chamber is removed, clean water can be returned from the liquid outlet into the aquarium tank, so that the air bubbles with buoyancy rising in the liquid water inside the foam generating chamber drive the liquid water in the aquarium tank to circulate through the liquid inlet and enter into the foam generating chamber to produce the effects of clearing and cleaning the produced protein dirt continuously, so as to maintain a good quality of the liquid water in the aquarium tank for a long time easily.

Another objective of the present invention is to provide a dirt disposal structure of an aquarium protein skimmer, wherein a sealed foam generating chamber is disposed at the bottom of the container body, and a pipe connection opening and a liquid outlet are formed at the container body, such that a liquid-gas mixing motor of a liquid-gas mixing device is entered from an air-water mixing end of an air-water delivery element coupled to the pipe connection opening of the container body into the foam generating chamber, and connected to external air from an air inlet pipe coupled to a suction pipe on the air-water mixing module. With the operation of the liquid-gas mixing motor, when the liquid water in the aquarium tank is pumped into the foam generating chamber through the suction pipe, the liquid delivered from the air-water delivery element is mixed with air to produce a large quantity of fine air bubbles, and the air bubbles bring the protein dirt in water to rise and pass through the pores of the dirt disposal portion of the air bubble guide column and flow into the dirt collection box. After foam in the foam generating chamber is removed, clean water can be returned from the liquid outlet into the aquarium tank and circulated back to the foam generating chamber to achieve the effects of removing or clearing the protein dirt continuously, so as to maintain a good quality of the liquid water in the aquarium tank effectively.

Another objective of the present invention is to provide a dirt disposal structure of an aquarium protein skimmer, wherein the container body has a foam generating chamber therein, and a sealed air-water mixing chamber is formed at the bottom of the foam generating chamber, and the air-water mixing chamber is interconnected with the outside through a water filling inlet and a liquid outlet, and at least one through hole and a liquid return hole are formed between the air-water mixing chamber and the foam generating chamber, and a water pump of a liquid-gas mixing device is used to connect a water filling inlet connected to a water filling end and an air inlet pipe to the external air. Through the suction pipe of the water pump, the liquid water in the aquarium tank is pumped. When the water filling end mixes air and fills the air into the air-water mixing chamber, air is mixed into the whirled water in the air-water mixing chamber, so that a large quantity of fine air bubbles can be produced from the through hole towards the foam generating chamber above, and the air bubbles bring the protein dirt in the water to rise and pass through the pores of the dirt disposal portion of the air bubble guide column and flow into the dirt collection box. After the foam in the foam generating chamber is removed, clean water is returned into the air-water mixing chamber along the return hole and then discharged back from the liquid outlet into the aquarium tank, so that the protein dirt in liquid water in the aquarium tank can be removed or cleared to achieve the effect of maintaining a good quality of liquid water in the aquarium tank.

The above and other objects, features and advantages of the invention will become apparent from the following detailed description taken with the accompanying drawings.

### BRIEF DESCRIPTION OF THE DRAWINGS

FIG. 1 is a perspective view of the structure of the present invention;

FIG. 2 is a cross-sectional view of a dirt disposal portion of the present invention;

FIG. 3 is a cross-sectional view of an air pump type liquid-gas mixing device used in a preferred embodiment of the present invention;

FIG. 4 is a cross-sectional view of an integral water pump type liquid-gas mixing device used in a preferred embodiment of the present invention;

FIG. 5 is a cross-sectional view of an external hanging water pump type liquid-gas mixing device used in a preferred embodiment of the present invention; and

FIG. 6 is a cross-sectional view of a separate water pump type liquid-gas mixing device used in a preferred embodiment of the present invention.

### DETAILED DESCRIPTION OF THE INVENTION

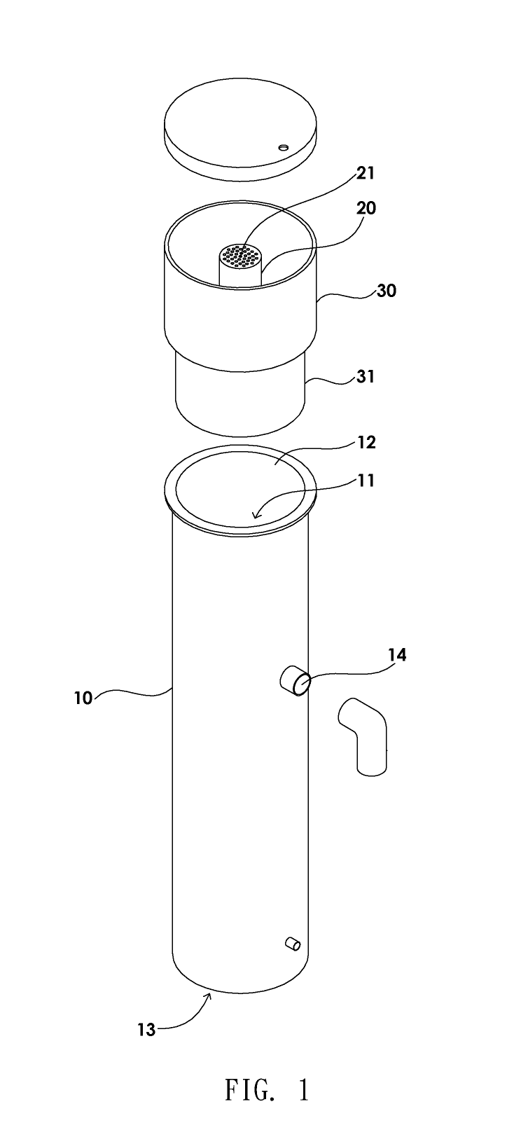

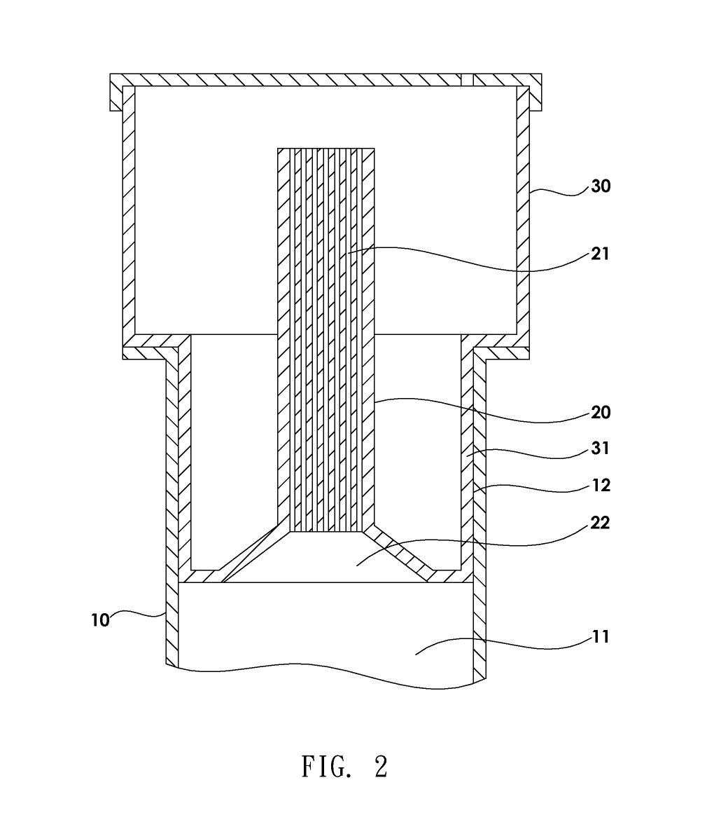

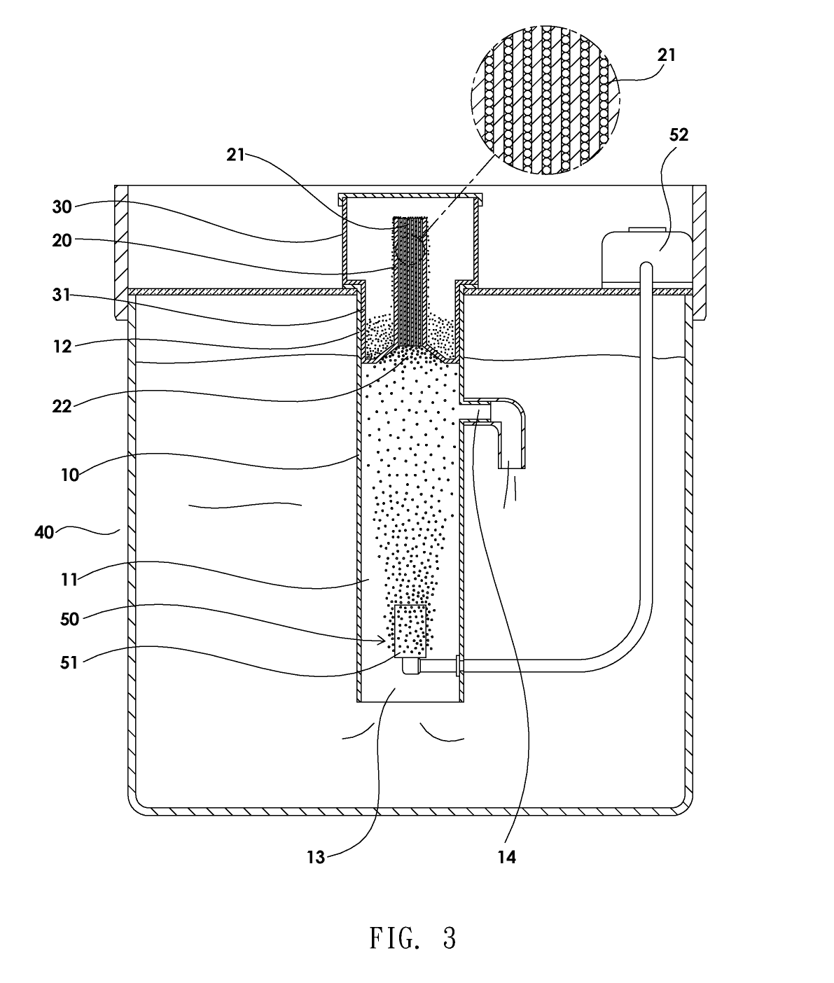

With reference to FIGS. 1 and 2 for a dirt disposal structure of an aquarium protein skimmer in accordance with the present invention, a container body 10 includes a foam generating chamber 11, and a dirt disposal portion 20 is disposed at an upper end of the foam generating chamber 11, and a ventilation hole and a breathable dirt collection box 30 are formed outside the outlet end of the dirt disposal portion 20, wherein the dirt disposal portion 20 is a porous bubble guide column having a plurality of pores 21 formed in an axial direction of the column for interconnecting the dirt collection box 30 to the foam generating chamber 11. In FIG. 3, the liquid water in the aquarium tank 40 is entered into the foam generating chamber 11 of the container body 10 by the operation of the liquid-gas mixing device 50 to produce fine air bubbles. The fine air bubbles damage the protein structure in water, so that the small protein or peptide dirt attached on the air bubbles attach flows to the dirt disposal portion 20, and when the air bubbles pass through the pores 21 of the dirt disposal portion 20 of the air bubble guide column to discharge air, the fine air bubbles with buoyancy rise to the inlet positions of pores 21, and a weak pushing force produced by the capillary action of the pores 21 causes the fine air bubbles to enter into the pores 21 continuously, and rise to bring the attached small protein or peptide dirt to the outlet positions of the pores 21. As the air bubbles in form of foam are cracked at the outlet positions, the small protein or peptide dirt can be discharged or permeated from the outlet positions of the pores 21 to flow to the dirt collection box 30 for the collection. Since the rising air bubbles (which will be expanded) entered continuously into the pores 21 only contain a very small amount of moisture, therefore the small protein or peptide dirt is discharged in a concentrated form, so that the collection space of the dirt collection box 30 can collect less liquid water and store concentrated small protein or peptide dirt temporarily, so as to avoid cleaning the dirt of the dirt collection box 30 too frequently. When the small protein or peptide dirt in the pores 21 rises together with the air bubbles to the outlet, other rising air bubbles following an air bubble will stop that particular air bubble from returning to the foam generating chamber 11 or the aquarium tank 40, so as to assure the effectiveness of discharging the protein dirt and improve the efficiency of removing the protein dirt.

Based on the aforementioned preferred embodiment as shown in FIGS. 1 and 2, a socket 12 is formed at an upper end of the container body 10, and the dirt disposal portion 20 of the air bubble guide column is disposed inside the dirt collection box 30, and a stair-like installing portion 31 is disposed at an external bottom of the dirt collection box 30 and opposite to the socket 12 of the container body 10. The installing portion 31 of the dirt collection box 30 is sheathed on the socket 12 of the container body 10 as shown in FIGS. 2 and 3, so that the inlets of the pores 21 of the dirt disposal portion 20 of the air bubble guide column can be extended deeply into the foam generating chamber 11 of the container body 10. When the fine air bubbles floating in the foam generating chamber 11 reach the inlets of the pores 21, the air bubbles are entered into the pores 21 naturally, and moved together with the small protein or peptide dirt to the outlet and discharged from the outlet and collected by the dirt collection box 30. Users simply withdraw the installing portion 31 of the dirt collection box 30 directly from the socket 12 (not shown in the figure) of the container body 10 to clean or clear the dirt in the dirt collection box 30 and the pores 21 of the dirt disposal portion 20 easily.

Based on the aforementioned preferred embodiment as shown in FIG. 2, the dirt disposal portion 20 of the air bubble guide column has a plurality of pores 21 interconnected to the dirt collection box 30 and the foam generating chamber 11, and a flared guide port 22 is formed at an inlet end of the pores 21 of the dirt disposal portion 20 of the air bubble guide column. In FIG. 3, the air bubbles rising to the top of the foam generating chamber 11 are guided by the guide port 22 to achieve the effect of concentrating the air bubbles at the inlet positions of the pores 21, so as to achieve the effect of rising and entering the air bubbles into the pores 21 smoothly.

Based on the aforementioned preferred embodiment as shown in FIGS. 1 and 3, a liquid inlet 13 is formed at the bottom of foam generating chamber 11 of the container body 10, and the foam generating chamber 11 is interconnected to the outside through a liquid outlet of the container body 10, and the container body 10 is submerged into the aquarium tank 40, and a wooden air stone 51 of an air pump liquid-gas mixing device 50 is disposed in the liquid inlet 13 of the container body 10 and coupled to an air pump 52. The air pump 52 is used for inputting air to the wooden air stone 51, so that a large quantity of fine air bubbles is produced at the liquid inlet 13, and the air bubbles bring the protein dirt in water to rise and pass through the pores 21 of the dirt disposal portion 20 of the air bubble guide column and discharge into the dirt collection box 30. After the foam in the foam generating chamber 11 is removed, clean water can return into the aquarium tank 40 through the liquid outlet 14, and the liquid water with the rising air bubbles having buoyancy in the foam generating chamber 11 is circulated from the liquid inlet 13 into the foam generating chamber 11, so that the protein dirt in the aquarium tank 40 is removed or cleared continuously to maintain a good water quality of the aquarium tank 40 for a long time easily.

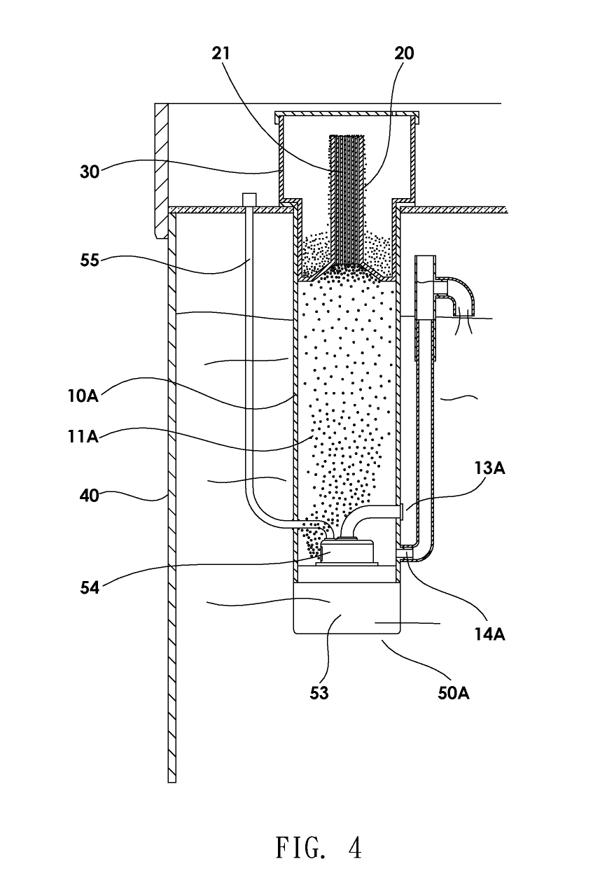

Based on the aforementioned preferred embodiment, the present invention can achieve the effect of removing or clearing the dirt in the liquid water of the aquarium tank. In FIG. 4, the container body 10A includes a foam generating chamber 11, and a liquid inlet 13A formed at the container body 10A and a liquid outlet 14A coupled to an output water level guide pipe, such that the container body 10A is submerged in the aquarium tank 40, and a liquid-gas mixing motor 53 of a water pump type liquid-gas mixing device 50A is installed at the internal bottom of the foam generating chamber 11A, and an air-water mixing module 54 of the liquid-gas mixing motor 53 is coupled to the liquid inlet 13A and interconnected with the liquid water of the aquarium tank 40 and connected to the external air through an air inlet pipe 55. With the operation of the liquid-gas mixing motor 53, when the liquid water in the aquarium tank 40 is pumped into the foam generating chamber 11A, a large quantity of fine air bubbles is produced by the air-water mixing module 54, and used for bringing the protein dirt to rise and pass through the pores 21 of the dirt disposal portion 20 of the air bubble guide column, and flowing and discharging the protein dirt into the dirt collection box 30. After the foam in the foam generating chamber 11A is removed, clean water is returned from the liquid outlet 14A into the aquarium tank 40, and re-circulated into the foam generating chamber 11A to produce the effects of clearing and removing the protein dirt continuously, so as to achieve the effect of obtaining a good water quality of the aquarium tank 40 effectively.

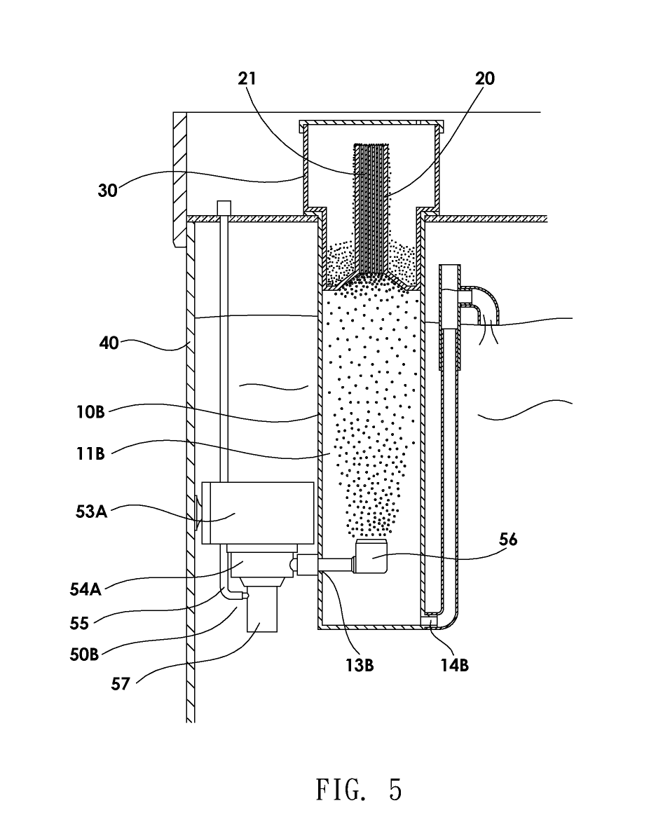

Based on the aforementioned preferred embodiment, the present invention further achieves the effect of removing or clearing the dirt in the liquid water in the aquarium tank. In FIG. 5, a sealed foam generating chamber 11B is disposed at the bottom of the container body 10B, and a pipe connection opening 13B is formed at the container body 10B, and a liquid outlet 14B is coupled to an output water level guide pipe. An external hanging liquid-gas mixing motor 53A of an external hanging water pump type liquid-gas mixing device 50B is installed, wherein an air-water delivery element 56 extended from the air-water mixing end to the pipe connection opening 13B of the container body 10B is entered into the foam generating chamber 11B, and an air inlet pipe 55 coupled to a suction pipe 57 on the air-water mixing module 54A is connected to external air. With the operation of the liquid-gas mixing motor 53A, when the liquid water in the aquarium tank 40 is pumped into the foam generating chamber 11B through the suction pipe 57, the liquid water entered from the air-water delivery element 56 is mixed with air to produce a large quantity of fine air bubbles, and the air bubbles bring the protein dirt in water to rise and pass through the pores 21 of the dirt disposal portion 20 of the air bubble guide column, and discharge the protein dirt into the dirt collection box 30. After the foam in the foam generating chamber 11B is removed, clean water is returned from the liquid outlet 14B into the aquarium tank 40 are re-circulated into the foam generating chamber 11B to produce the effects of clearing and removing the protein dirt continuously, so as to achieve the effect of obtaining a good water quality of the aquarium tank 40 effectively.

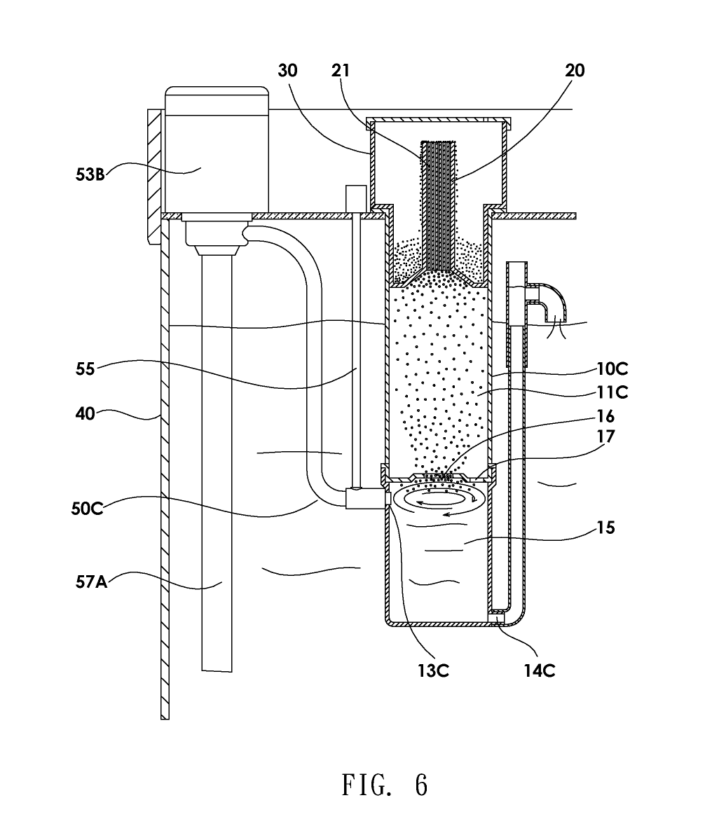

Based on the aforementioned preferred embodiment, the present invention further achieves the effect of removing or clearing the dirt in the water of the aquarium tank. In FIG. 6, the container body 10C includes a foam generating chamber 11C, a sealed air-water mixing chamber 15 formed at the bottom of the foam generating chamber 11C and interconnected to the outside through a water filling inlet 13C and a liquid outlet 14C coupled to the output water level guide pipe, and at least one through hole 16 and a liquid return hole 17 are formed between the sealed air-water mixing chamber 15 and the foam generating chamber 11C. An off-water water pump 53B of a separate water pump type liquid-gas mixing device 50C is installed, the water filling inlet 13C is coupled to the water filling end and an air inlet pipe 55 is connected to external air. By pumping the water in the aquarium tank 40 through the suction pipe 57A of the water pump 53B, when the water in the water filling end is mixed with air and injected into air-water mixing chamber 15, the whirled water filled into the air-water mixing chamber 15 and mixed with air can rise from the through hole 16 to the foam generating chamber 11C above to produce a large quantity of fine air bubbles, and the air bubbles bring the protein dirt in the water to rise and pass through the pores 21 of the dirt disposal portion 20 of the air bubble guide column and discharge the protein dirt into the dirt collection box 30. After the foam in the foam generating chamber 11C is removed, clean water is returned from the return hole 17 into the air-water mixing chamber 15, and then discharged from the liquid outlet 14C into the aquarium tank 40 to cyclically remove or clear the protein dirt in the liquid water of the aquarium tank, so as to maintain a good water quality of the aquarium tank 40.

While the invention has been described by means of specific embodiments, numerous modifications and variations could be made thereto by those skilled in the art without departing from the scope and spirit of the invention set forth in the claims.

What is claimed is:

1. A dirt disposal structure of an aquarium protein skimmer, comprising a container body, a foam generating chamber disposed in the container body, a dirt disposal portion disposed at an upper end of the foam generating chamber, and a breathable dirt collection box installed outside an outlet end of the dirt disposal portion, characterized in that the dirt disposal portion is a porous bubble guide column having a plurality of pores formed in an axial direction of the column for interconnecting the dirt collection box with the foam generating chamber.

2. The dirt disposal structure of an aquarium protein skimmer according to claim 1, wherein the container body has a socket formed at an upper end of the container body, and the dirt disposal portion of the air bubble guide column is disposed inside the dirt collection box, and an installing portion is formed at the external bottom of the dirt collection box and opposite to the socket of the container body and the installing portion of the dirt collection box is sheathed on the socket of the container body.

3. The dirt disposal structure of an aquarium protein skimmer according to claim 1, wherein the dirt disposal portion of the air bubble guide column has a plurality of pores interconnected with the dirt collection box and the foam generating chamber, and a flared guide port is formed at an inlet end of the pores of the dirt disposal portion of the air bubble guide column.

4. The dirt disposal structure of an aquarium protein skimmer according to claim 1, wherein the foam generating chamber of the container body has a liquid inlet formed at the bottom of the foam generating chamber, and the foam generating chamber is interconnected to the outside through a liquid outlet of the container body, and the container body is submerged into an aquarium tank, and a wooden air stone of a liquid-gas mixing device is disposed in the liquid inlet of the container body and coupled to an air pump.

5. The dirt disposal structure of an aquarium protein skimmer according to claim 1, wherein the container body has a foam generating chamber formed therein, and a liquid inlet and a liquid outlet formed on the container body, and the container body is submerged into an aquarium tank, and a liquid-gas mixing motor of a liquid-gas mixing device is installed at the internal bottom of the foam generating chamber, and an air-water mixing module disposed on the liquid-gas mixing motor is coupled to the liquid inlet and connected to external air through an air inlet pipe.

6. The dirt disposal structure of an aquarium protein skimmer according to claim 1, wherein the container body has a sealed foam generating chamber formed at the bottom of the container body, and a pipe connection opening and a liquid outlet formed at the container body, and a liquid-gas mixing motor of a liquid-gas mixing device has an air-water delivery element extended from an air-water mixing end of a pipe connection opening of the container body into the foam generating chamber, and connected to external air through an air inlet pipe coupled to a suction pipe on the air-water mixing module.

7. The dirt disposal structure of an aquarium protein skimmer according to claim 1, wherein the container body has a foam generating chamber formed therein, a sealed air-water mixing chamber formed at the bottom of the foam generating chamber, and a water filling inlet and a liquid outlet for interconnecting the air-water mixing chamber with the outside, and at least one through hole and a liquid return hole are formed between the air-water mixing chamber and the foam generating chamber, and a water pump of a liquid-gas mixing device is coupled to the water filling inlet through a water filling end of the water pump and has an air inlet pipe connected to external air.
